(19) United States
(12) Patent Application Publication
(10) Pub. No.: US 2013/0208163 A1
(43) Pub. Date: Aug. 15, 2013

(54) CAMERA SHUTTER KEY DISPLAY APPARATUS AND METHOD

(71) Applicant: Samsung Electronics Co., Ltd., (US)

(72) Inventors: Soon-Kyoung CHOI, Seoul (KR); Dong-Youl Park, Gyeonggi-do (KR); Jae-Myung Baek, Gyeonggi-do (KR); Young-Kwon Yoon, Seoul (KR)

(73) Assignee: Samsung Electronics Co., Ltd., Gyeonggi-do (KR)

(21) Appl. No.: 13/761,890

(22) Filed: Feb. 7, 2013

(30) Foreign Application Priority Data
Feb. 10, 2012 (KR) 10-2012-0013778

(51) Int. Cl. H04N 5/232

(52) U.S. Cl. CPC H04N 5/23293
USPC 348/333.01

(57) ABSTRACT

A camera shutter key display apparatus includes a display module to display an image captured by a camera unit, and to display a camera shutter key, an input module to provide a key input signal through a touch or a press by a user, and a controller to proceed with a camera shutter key shift mode so that a camera shutter key shift location is selected when a camera shutter key shift request is received from the user through the input module, and controlling to display the camera shutter key on the selected shift location. Accordingly, the user can readily manipulate the camera shutter key on a camera user interface screen, and conveniently and readily performs image capturing by shifting the camera shutter key to a desired location and displaying the camera shutter at the desired location.

### PRIORITY

This application claims priority under 35 U.S.C. §119(a) to Korean Application Serial No. 10-2012-0013778, which was filed in the Korean Intellectual Property Office on Feb. 10, 2012, the entire content of which is hereby incorporated by reference.

### BACKGROUND OF THE INVENTION

1. Field of the Invention The present invention relates generally to a camera shutter key, and more particularly, to a camera shutter key display method and apparatus.

2. Description of the Related Art

As digital cameras have become widely popular, the camera has become common place as a general electric device. The frequency of use of the camera is increasing day by day so that not only the digital camera itself, but also various mobile terminals, such as a cellular phone, a smart phone, and the like, contain a camera. In accordance with this trend, a User Interface (UI) for manipulating the camera has also been continuously developed. The UI for manipulating the camera may include, for example, a zoom key to manipulate zooming in and out, a shutter key to capture a picture, and the like.

Conventionally, a UI of a camera is configured to structurally protrude from a camera case, such as manipulation buttons. However, as touch screen technology is now widely utilized, a scheme of displaying keys operated by a touch on a touch screen has been primarily used.

Particularly, as an example of a camera UI in a mobile terminal including a camera, FIG. 1 illustrates a UI screen for capturing images in a mobile terminal including a conventional camera. Referring to FIG. 1, the mobile terminal including the conventional camera provides a camera UI screen 10 for capturing a moving picture and/or a still image. The mobile terminal displays, on the camera UI screen 10, a preview image 12 input through a camera module and various camera function manipulating keys 14 including a shutter key S for capturing a moving picture and/or still image. Accordingly, a user may manipulate a camera function by touching a desired key from among the shutter key S or the various camera function manipulating keys 14.

However, camera function manipulating keys on a conventional camera user interface (UI) screen are fixedly displayed at predetermined locations. Accordingly, a user may need to touch a key at a predetermined location when the user desires to manipulate a camera function. Particularly, when the user desires to capture a moving picture and/or a still image, the user may touch or press a shutter key S at a predetermined location with a finger or a touch pointer.

However, when the user captures a moving picture and/or a still image using a mobile terminal including a camera, the user may have difficulty in touching the shutter key S at the predetermined location depending on a posture of the user. For example, when the user performs capturing by holding a camera with a single hand, for example, a right hand, the user needs to press the shutter key S with one of the fingers of the right hand. In this example, when the shutter key S is disposed at a location where the finger does not reach, the user may have difficulty in pressing the shutter key S, and it is difficult to capture an image.

Also, when the shutter key S is disposed on the right side of the camera interface screen, a left-handed user may have difficulty in pressing or touching the shutter key S disposed on the right side while capturing an image.

### SUMMARY OF THE INVENTION

Accordingly, the present invention has been made to address at least the above-described problems occurring in the prior art, and to provide at least the advantages described below.

An aspect of the present invention is to provide a camera shutter key display method and apparatus that displays a camera shutter key at a desired location by shifting the camera shutter key on a camera UI screen to the desired location where the user can readily manipulate the camera shutter key.

Another aspect of the present invention is to provide a camera shutter key display method and apparatus that displays a camera shutter key by shifting the camera shutter key on a camera UI screen based on various schemes.

In accordance with an aspect of the present invention, a camera shutter key display apparatus is provided. The apparatus includes a display module to display an image captured by a camera unit and to display a camera shutter key, an input module to provide a key input signal through a touch or a press by a user, and a controller to proceed with a camera shutter key shift mode so that a camera shutter key shift location is selected when a camera shutter key shift request is received from the user through the input module, and to control to display the camera shutter key at the selected shift location.

In accordance with another aspect of the present invention, a camera shutter key display method is provided. The method includes receiving a camera shutter key shift request, proceeding with a camera shutter key shift mode so that a camera shutter key shift location is selected, and controlling to display the camera shutter key at the selected shift location.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram illustrating a user interface screen for capturing an image in a mobile terminal including a conventional camera;

FIG. 2 is a block diagram illustrating a camera shutter key display apparatus according to embodiments of the present invention;

FIG. 3 is a flowchart illustrating a camera shutter key display method according to embodiments of the present invention;

FIGS. 4A and 4B are diagrams illustrating a shift of a camera shutter key based on a drag scheme according to an embodiment of the present invention;

FIGS. 5A through 5C are diagrams illustrating a shift of a camera shutter key based on a menu selection scheme according to another embodiment of the present invention;

FIG. 6 is a diagram illustrating a shift of a camera shutter key based on a location designating scheme according to another embodiment of the present invention;

FIG. 7 is a diagram illustrating a shift of a camera shutter key based on a direction key input scheme according to another embodiment of the present invention; and

FIG. 8 is a diagram illustrating a shift of a camera shutter key based on a location selection scheme according to another embodiment of the present invention.

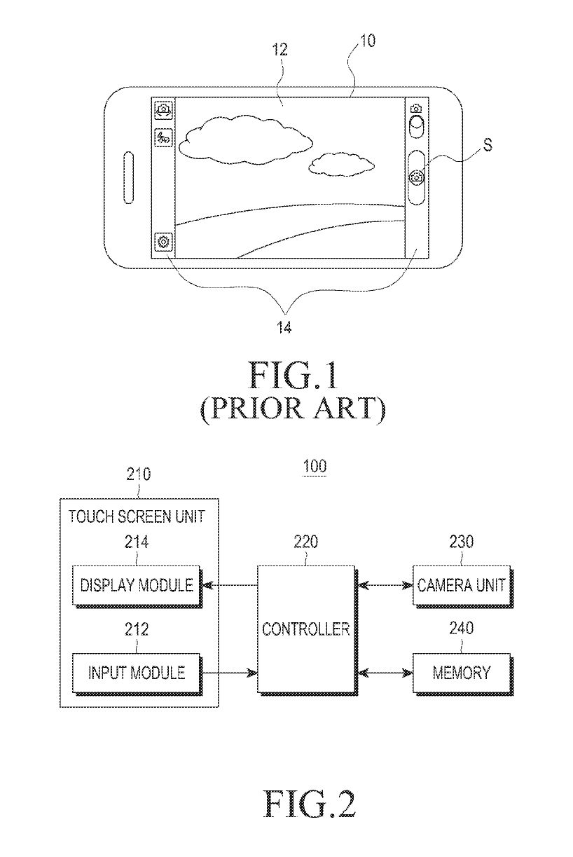

### DETAILED DESCRIPTION OF EMBODIMENTS OF THE PRESENT INVENTION

Hereinafter, various embodiments of the present invention will be described with reference to the accompanying drawings. In addition, various specific definitions found in the following description are provided only to provide a general understanding of the present invention, and it is apparent to those skilled in the art that modifications can be made without departing from the scope of the invention. Further, in the following description of the present invention, a detailed description of known functions and configurations incorporated herein will be omitted when it may make the subject matter of the present invention unclear.

The present invention provides a camera shutter key display method and apparatus that enables a user to select a camera shutter key shift location for a camera shutter key displayed on a camera user interface in response to a camera shutter key shift request from the user, and displays the camera shutter key on the selected shift location. Embodiments of the present invention may be applied to a camera, a mobile terminal including a camera function, and to any device that includes a camera user interface such as a camera module, a touch screen, and the like. The embodiments of the present invention will describe a case in which the camera shutter key display apparatus is applied to a mobile terminal including a camera function.

FIG. 2 is a block diagram illustrating a configuration of a mobile terminal including a camera function according to embodiments of the present invention. Referring to FIG. 2, a mobile terminal 100 includes a touch screen unit 210, a controller 220, a camera unit 230, and a memory 240.

The touch screen unit 210 includes an input module 212 and a display module 214. The input module 212 senses a touch or a press by a user on various keys embodied on the display module 214 in a software manner, and transfers, to the controller 220, a key input signal from the touch or press by the user. The display module 214 may be configured of a Liquid Crystal Display (LCD) and the like, and receives display data from the controller 220 and displays the received display data. For example, the display module 214 displays a plurality of character keys for inputting number and character information and the like in an idle mode, and control keys for controlling an operation of the mobile terminal 100. In particular, the display module 214 displays a preview screen associated with an image captured by the camera unit 230 in a camera capturing mode according to an embodiment of the present invention, and displays a camera shutter key on the preview screen.

The controller 220 performs general control operations of the mobile terminal 100. Also, the controller 220 proceeds with a camera shutter key shift mode when a camera shutter key shift request is received from the user through the input module 212 according to an embodiment of the present invention. When a camera shutter key shift location is selected by the user through the input module 212, the controller 220 controls the display module 214 to display the camera shutter key at the selected location. Also, when setting a transparency of the camera shutter key displayed on the display module 214 is required, the controller 220 adjusts the transparency of the camera shutter key based on a predetermined transparency or adjusts the transparency of the camera shutter key by receiving a transparency of the camera shutter key input by the user.

The camera unit 230 includes a camera sensor to capture an image through a lens and to convert a captured optical signal into an electric signal, and a signal processing unit to convert an analog image signal captured by the camera sensor into digital data. Here, the camera sensor may be embodied as a Charge Coupled Device (CCD) sensor, and the signal processing unit may be embodied as a Digital Signal Processor (DSP), but are not limited thereto.

The memory 240 may be configured of a non-volatile memory embodied as a flash memory, a hard disk, and the like, and stores data or programs required for the operation of the mobile terminal 100. Particularly, according to an embodiment of the present invention, the memory 240 stores a moving picture and/or still image captured by the camera.

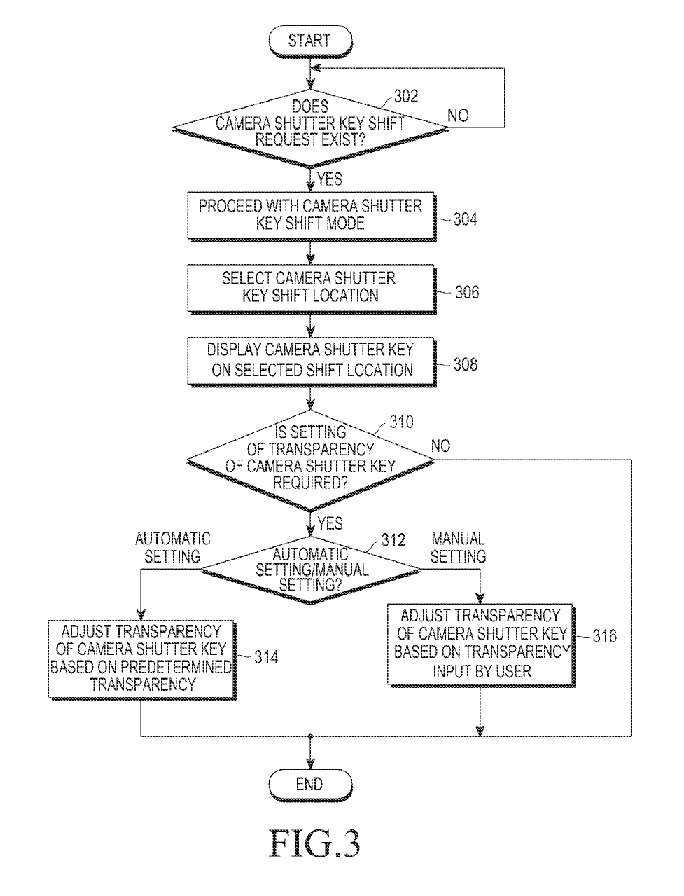

Hereinafter, operations of a mobile terminal including a camera function according to an embodiment of the present invention will be described with reference to FIG. 3, which is a flowchart illustrating operations of a mobile terminal including a camera function.

Referring to FIG. 3, the mobile terminal 100 determines whether a camera shutter key shift request exists in step S302. The mobile terminal 100 determines that the camera shutter key shift request exists when an input corresponding to the camera shutter key shift request is received from a user through the input module 212 of the touch screen unit 210 in a camera capturing mode. In this example, the input corresponding to the camera shutter key shift request may correspond to a long-touch input for a camera shutter key by the user, a selection input for a shutter key shift request menu item by the user, a preview screen touch input in a state where a preview screen is displayed, a direction key input, and the like.

The mobile terminal 100 proceeds with a camera shutter key shift mode in step S304 when the camera shutter key shift request exists, and selects a camera shutter key shift location in step S306. For example, the mobile terminal 100 may select, to be the camera shutter key shift location, a location designated by a dragging motion in a state where the camera shutter key is touched by the user. Also, the mobile terminal 100 may select a touched location to be the camera shutter key shift location when a predetermined location of the preview screen is touched by the user. Further, the mobile terminal 100 shifts the camera shutter key based on a direction key input by the user, and selects the shifted camera shutter key location. The mobile terminal 100 also displays a camera shutter key location candidate on a predetermined location of the preview screen, and selects a location candidate selected by the user to be the camera shutter key shift location.

When the camera shutter key shift location is selected, the mobile terminal 100 displays the camera shutter key on the selected shift location in step S308.

Subsequently, the mobile terminal 100 determines whether setting of a transparency level of the camera shutter key is required in step S310. When setting of the transparency level of the camera shutter key is not required, the process ends. When setting of the transparency level of the camera shutter key is required, the mobile terminal 100 determines whether setting of the transparency level is to be performed automatically or manually in step S312. In this example, whether to perform automatic/manual setting may be determined by the user in advance, or may be determined by the mobile terminal 100 based on a predetermined criterion.

In the case of automatic setting, the mobile terminal 100 adjusts the transparency level of the camera shutter key based on a predetermined transparency level in step S314. In this example, it is desirable that the transparency level is adjusted to be the predetermined transparency level, such as 50%, so that the user has no difficulty in viewing a preview screen due to the camera shutter key.

In the case of manual setting, the mobile terminal 100 adjusts the transparency level of the camera shutter key based on a transparency input by the user in step S316. In this example, the user may adjust the transparency level of the camera shutter key by inputting a desired transparency level.

As described in the foregoing, the mobile terminal including a camera function according to an embodiment of the present invention enables a user to select a camera shutter key shift location in response to a camera shutter key shift request from the user, and shifts a camera shutter key to the selected camera shutter key shift location. According to an embodiment of the present invention, various schemes may be used for selecting the camera shutter key shift location. Embodiments of the present invention provide at least a long-touch-and-drag scheme, a menu selection-and-drag scheme, a location designating scheme on a preview screen, a direction key input scheme, and a location selection scheme.

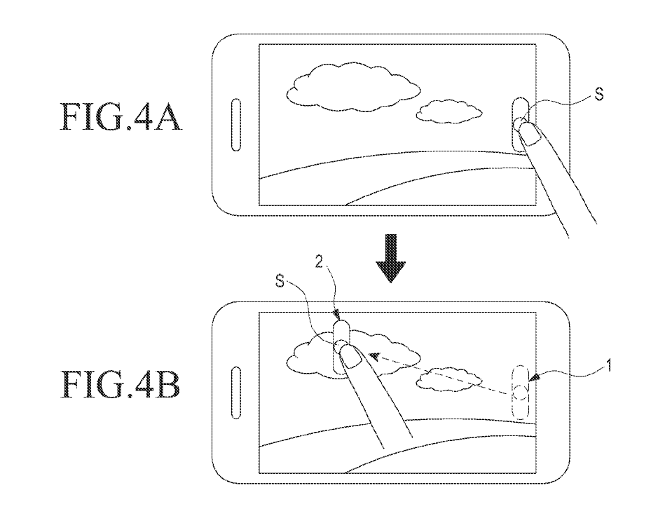

First, the long-touch-and-drag scheme will be described. FIGS. 4A and 4B are diagrams illustrating a shift of a camera shutter key based on the long-touch-and-drag scheme according to an embodiment of the present invention. Referring to FIGS. 4A and 4B, a user may input a camera shutter key shift request by performing a long-touch on a camera shutter key S in a state where the camera shutter key S is displayed on a preview screen as illustrated in FIG. 4A. When the input of the camera shutter key shift request is received, the mobile terminal 100 proceeds with a camera shutter key shift mode. When the camera shutter key S is dragged by the user from a location 1 to a location 2 in the camera shutter key shift mode as illustrated in FIG. 4B, the mobile terminal 100 recognizes that the location 2 is selected to be the camera shutter key shift location, and displays the camera shutter key S at the location 2.

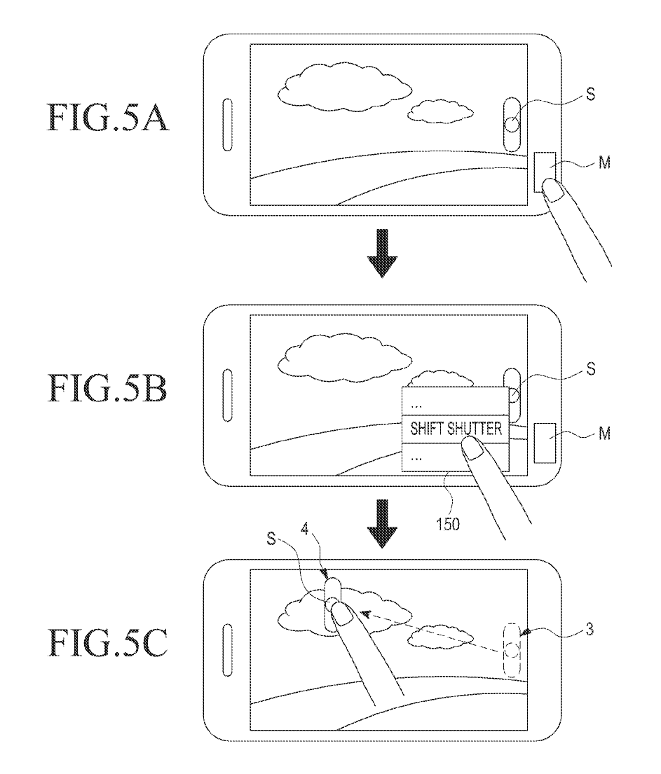

The menu selection-and-drag scheme will now be described. FIGS. 5A through 5C are diagrams illustrating a shift of a camera shutter key based on the menu selection-and-drag scheme according to another embodiment of the present invention. Referring to FIGS. 5A through 5C, a user presses a menu (M) key in a state where a camera shutter key S is displayed on a preview screen as illustrated in FIG. 5A and selects a “shift shutter” menu on a menu selection screen 150 as illustrated in FIG. 5B, so as to input a camera shutter key shift request. When the input of the camera shutter key shift request is received, the mobile terminal 100 proceeds with a camera shutter key shift mode. When the camera shutter key S is dragged by the user from a location 3 to a location 4 in the camera shutter key shift mode as illustrated in FIG. 5C, the mobile terminal 100 recognizes that the location 4 is selected to be a camera shutter key shift location, and displays the camera shutter key S at the location 4.

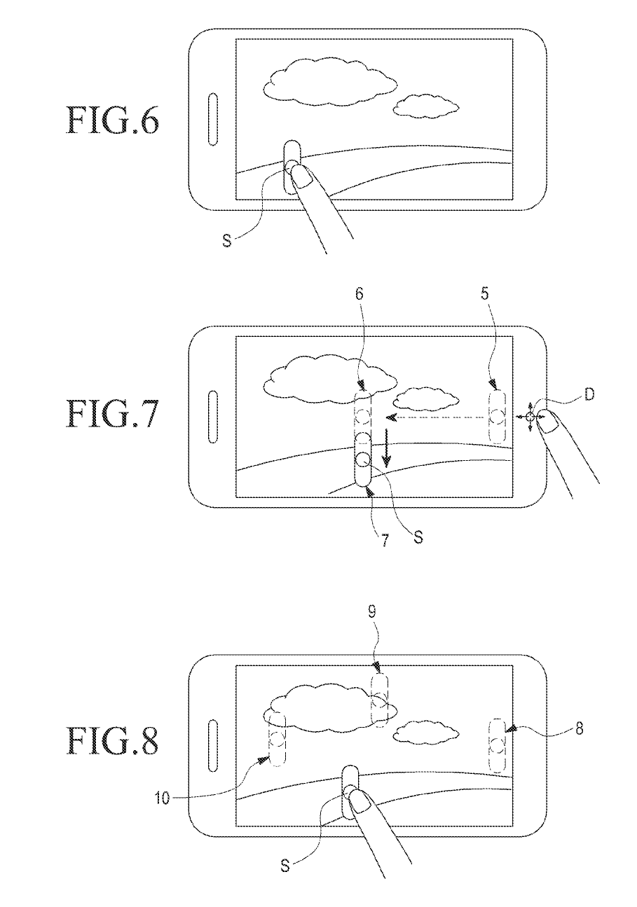

The location designating scheme on a preview screen will now be described. FIG. 6 is a diagram illustrating a shift of a camera shutter key based on the location designating scheme on a preview screen according to another embodiment of the present invention. Referring to FIG. 6, a user may input a camera shutter key shift request by touching a preview screen as illustrated in FIG. 6. When the input of the camera shutter key shift request is received, the mobile terminal 100 proceeds with a camera shutter key shift mode. When a preview touch by the user is continued during a predetermined period of time in the camera shutter key shift mode, the mobile terminal 100 recognizes that a touched location (designated location) is selected to be a shift location for the camera shutter key S, and displays the camera shutter key S at the selected location.

The direction key input scheme will now be described. FIG. 7 is a diagram illustrating a shift of a camera shutter key based on the direction key input scheme according to a further embodiment of the present invention. Referring to FIG. 7, a user may input a camera shutter key shift request by touching or pressing a direction key D as illustrated in FIG. 7. When the input of the camera shutter key shift request is received, the mobile terminal 100 proceeds with a camera shutter key shift mode. The mobile terminal 100 recognizes that a location 6 and a location 7 are selected based on an input for a shift to the left side and an input for a shift to the lower side through the direction key D in the camera shutter key shift mode, and shifts the camera shutter key S from the location 6 to the location 7 to display the camera shutter key S.

The location selection scheme will now be described. FIG. 8 is a diagram illustrating a shift of a camera shutter key based on the location selection scheme according to another embodiment of the present invention. Referring to FIG. 8, a user may input a camera shutter key shift request by touching a preview screen or selecting a menu. When an input of a camera shutter key shift request is received, the mobile terminal 100 proceeds with a camera shutter key shift mode, and displays selectable locations, for example, a location 8, a location 9, and a location 10. The mobile terminal 100 recognizes a camera shutter key shift location selected by the user from among the selectable locations, and displays the camera shutter key S on the selected location, for example, the location 11.

According to the embodiments of the present invention as described in the foregoing, a camera shutter key on a camera user interface screen is shifted to a desired location where a user readily manipulates the camera shutter key and thus, the user may conveniently and readily perform image capturing. Also, according to the embodiments of the present invention, various schemes for shifting a camera shutter key, such as a long-touch-and-drag scheme, a menu selection-and-drag scheme, a location designating scheme on a preview screen, a direction key input scheme, a location selection scheme, and the like, are provided and thus, a user may readily and conveniently shift a location of the camera shutter key using a desired scheme.

Although certain embodiments of the present invention have been provided, various modifications thereto can be made without departing from the scope of the present invention. For example, although the embodiments of the present invention have described a mobile terminal including a camera function as an example of the camera shutter key display apparatus, any device including a camera user interface for manipulating the camera function may be applicable. Also, although the embodiments of the present invention have described a long-touch-and-drag scheme, a menu selection-and-drag scheme, a location designating scheme on a preview screen, a direction key input scheme, and a location selection scheme as examples of a scheme for shifting a camera shutter key, other schemes that may shift a camera shutter key may be applicable. Therefore, the scope of the present invention should not be defined by the described embodiments, but should be defined by claims and equivalents thereof.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. A camera shutter key display apparatus, the apparatus comprising:
a display module to display an image captured by a camera unit, and to display a camera shutter key;
an input module to provide a key input signal from a touch or a press by a user; and
a controller to proceed with a camera shutter key shift mode so that a camera shutter key shift location is selected when a camera shutter key shift request is received from the user through the input module, and controlling to display the camera shutter key at the selected shift location.

2. The apparatus of claim 1, wherein a scheme of selecting the camera shutter key shift location corresponds to one of a long-touch-and-drag scheme, a menu selection-and-drag scheme, a location designating scheme on a preview screen, a direction key input scheme, and a location selection scheme.

3. The apparatus of claim 1, wherein the controller adjusts a transparency level of the camera shutter key.

4. The apparatus of claim 3, wherein the controller adjusts the transparency level of the camera shutter key based on a predetermined transparency level.

5. The apparatus of claim 3, wherein the controller adjusts the transparency level of the camera shutter key based on a transparency level input by the user.

6. A camera shutter key display method, the method comprising:
receiving a camera shutter key shift request;
proceeding with a camera shutter key shift mode so that a camera shutter key shift location is selected; and
controlling to display the camera shutter key at the selected shift location.

7. The method of claim 6, wherein a scheme of selecting the camera shutter key shift location corresponds to one of a long-touch-and-drag scheme, a menu selection-and-drag scheme, a location designating scheme on a preview screen, a direction key input scheme, and a location selection scheme.

8. The method of claim 6, further comprising:
adjusting a transparency level of the camera shutter key.

9. The method of claim 8, wherein the transparency level of the camera shutter key is adjusted based on a predetermined transparency level.

10. The method of claim 8, wherein the transparency level of the camera shutter key is adjusted based on a transparency level input by the user.
